(19) United States
(12) Patent Application Publication
(10) Pub. No.: US 2026/0113070 A1
(43) Pub. Date: Apr. 23, 2026

(54) RADIO FREQUENCY SWITCHING CIRCUIT, RADIO FREQUENCY MODULE, AND COMMUNICATION APPARATUS

(71) Applicant: Murata Manufacturing Co., Ltd., Nagaokakyo-shi (JP)

(72) Inventor: Naoki MORIKAWA, Nagaokakyo-shi (JP)

(73) Assignee: Murata Manufacturing Co., Ltd., Nagaokakyo-shi (JP)

(21) Appl. No.: 19/351,347

(22) Filed: Oct. 7, 2025

(30) Foreign Application Priority Data
Oct. 21, 2024 (JP) 2024-185032

(51) Int. Cl. H04B 1/40; H04B 1/00; H04B 1/16

(52) U.S. Cl. CPC H04B 1/40; H04B 1/0078; H04B 1/1607

(57) ABSTRACT

A radio frequency switching circuit includes a common terminal, a first input/output terminal, a first serial FET, a first parallel FET, a charge pump, a voltage supply path, a first switch, and a second switch. The first serial FET is connected, on a first signal path L1, to the common terminal and the first input/output terminal. The first parallel FET 6 is connected between a signal path and ground. The voltage supply path is connected to a connection node connected to an output part of the charge pump and a control electrode of the first serial FET. The first switch is provided on a first path connecting the output part of the charge pump and the connection node. The second switch is provided on the voltage supply path.

### CROSS-REFERENCE TO RELATED APPLICATION

The present application claims priority to Japanese patent application JP 2024-185032, filed Oct. 21, 2024, the entire contents of which being incorporated herein by reference

### BACKGROUND

### 1. Field

The present disclosure relates to a radio frequency switching circuit, a radio frequency module, and a communication apparatus and in more detail, relates to a radio frequency switching circuit including a common terminal and an input/output terminal, a radio frequency module including the radio frequency switching circuit, and a communication apparatus including the radio frequency module.

### 2. Description of the Related Art

A positive and negative voltage generation circuit described in Japanese Unexamined Patent Application Publication No. 2016-9938 includes a plurality of FETs and a power supply circuit that supplies a voltage to the plurality of FETs. The power supply circuit includes a charge pump. The charge pump applies a positive voltage to a predetermined FET of the plurality of FETs in turning on the predetermined FET and applies a negative voltage to the predetermined FET in turning off the predetermined FET.

### SUMMARY

In the positive and negative voltage generation circuit described in Japanese Unexamined Patent Application Publication No. 2016-9938, each FET receives a voltage close to zero volts in a state where the charge pump is stopped and thus does not have a sufficiently low ON resistance.

Accordingly, when a radio frequency signal from an external terminal apparatus enters and passes through the FET in the state where the charge pump is stopped, the ON resistance of the FET causes a reflected wave to be generated, and the generated reflected wave returns to the external terminal apparatus and causes the receiver sensitivity of the external terminal apparatus to be deteriorated on occasions.

Accordingly, in consideration of the issue above, the present disclosure is directed to providing a radio frequency switching circuit, a radio frequency module, and a communication apparatus that are enabled to reduce a reflected wave generated due to a radio frequency signal having entered from an external terminal apparatus in a state where a charge pump is stopped.

A radio frequency switching circuit according to an aspect of the present disclosure includes a common terminal, a first input/output terminal, a first serial FET, a first parallel FET, a charge pump, a voltage source, a voltage supply path, a first switch, and a second switch. The first input/output terminal is connected to the common terminal with a first signal path interposed therebetween. The first serial FET is connected, on the first signal path, to the common terminal and the first input/output terminal. The first parallel FET is connected between ground and a signal path between the first input/output terminal and the first serial FET. The charge pump has an output part and supplies, from the output part, a control voltage for controlling the first serial FET and a control voltage for controlling the first parallel FET. The voltage source has a first output part and a second output part that supply respective voltages. The voltage source supplies the voltage from the second output part to the charge pump. The voltage supply path connects the first output part of the voltage source and a connection node connected to a control electrode of the first serial FET. The first switch is provided on a first path connecting the output part of the charge pump and the connection node and turns the first path on and off. The second switch is provided on the voltage supply path and turns the voltage supply path on and off.

A radio frequency module according to an aspect of the present disclosure includes the radio frequency switching circuit and an electronic component. The electronic component is connected between the first input/output terminal of the radio frequency switching circuit and an external terminal.

A communication apparatus according to an aspect of the present disclosure includes the radio frequency module and a signal processing circuit. The signal processing circuit is connected to the radio frequency module and performs signal processing of a radio frequency signal.

With the radio frequency switching circuit, the radio frequency module, and the communication apparatus according to the present disclosure, the generation of a reflected wave may be reduced, the generation being caused by a radio frequency signal having entered from the external terminal apparatus in a state where the charge pump is stopped.

### BRIEF DESCRIPTION OF THE DRAWINGS

FIG. 1 is a diagram of the configuration of a radio frequency module and a communication apparatus according to Exemplary Embodiment 1;

FIG. 2 is a diagram of the configuration of a radio frequency switching circuit included in the radio frequency module;

FIG. 3 is a diagram of the configuration of a radio frequency switching circuit according to Exemplary Embodiment 2; and FIG. 4 is a diagram of the configuration of a radio frequency switching circuit according to Exemplary Embodiment 3.

### DESCRIPTION OF THE PREFERRED EMBODIMENTS

### 1 Exemplary Embodiment 1

A radio frequency switching circuit 1 according to Exemplary Embodiment 1 will be described in detail with reference to the drawings.

### 1-1 Overview

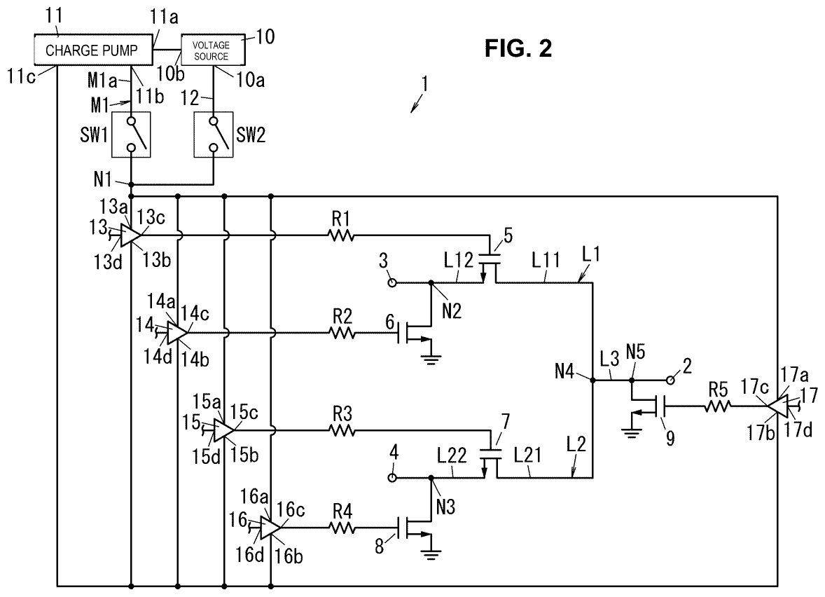

As illustrated in FIG. 2, the radio frequency switching circuit 1 according to Exemplary Embodiment 1 includes a common terminal 2, a first input/output terminal 3, a first serial field effect transistor (FET) 5, a first parallel FET 6, a charge pump 11, a voltage source 10, a voltage supply path 12, a first switch SW1, and a second switch SW2. The first input/output terminal 3 is connected to the common terminal 2 with a first signal path L1 interposed therebetween. The first serial FET 5 is connected to the common terminal 2 and the first input/output terminal 3 on the first signal path L1. The first parallel FET 6 is connected between ground and a signal path L12 between the first input/output terminal 3 and the first serial FET 5. The charge pump 11 has at least one output part, e.g., a first output part 11b and a second output part 11c. The charge pump 11 supplies, from the first output part 11b, a control voltage for controlling the first serial FET 5 and a control voltage for controlling the first parallel FET 6. The voltage source 10 has a first output part 10a and a second output part 10b that supply respective voltages. The voltage source 10 supplies the voltage from the second output part 10b to the charge pump 11. The voltage supply path 12 connects the first output part 10a of the voltage source 10 and a connection node N1 connected to a control electrode of the first serial FET 5. The first switch SW1 is provided on a first path M1 connecting the first output part 11b of the charge pump 11 and the connection node N1 and turns the first path M1 on and off.

The second switch SW2 is provided on the voltage supply path 12 and turns the voltage supply path 12 on and off.

With this configuration, in the state where the charge pump 11 is stopped, the first switch SW1 causes the first path M1 to turn off, and the second switch SW2 causes the voltage supply path 12 to turn on. Applying, to the control electrode of the first serial FET 5, a voltage (power supply voltage) applied to the voltage supply path 12 may thereby cause the state of the first serial FET 5 to switch to an on state where the ON resistance is sufficiently low. Accordingly, the generation of the reflected wave of the radio frequency may be reduced, the generation being caused by the ON resistance of the first serial FET 5 when the radio frequency signal having entered the common terminal 2 from the external terminal apparatus passes through the first serial FET 5 in the state the charge pump 11 is stopped. As the result, the deterioration of the receiver sensitivity of the external terminal apparatus may be reduced, the deterioration being caused by the returning of the reflected wave to the external terminal apparatus.

### 1-2 Communication Apparatus

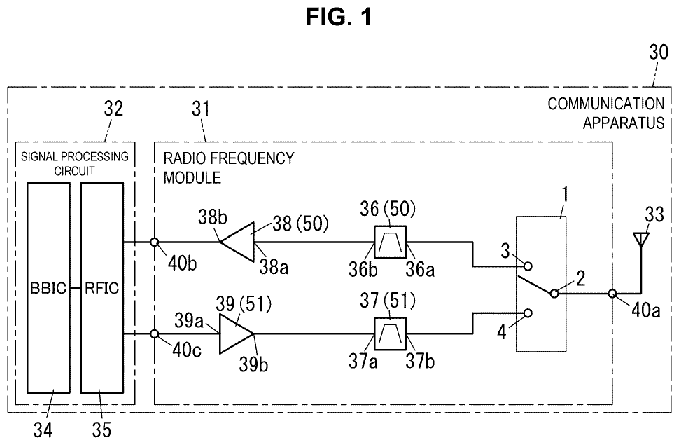

An example configuration of a communication apparatus 30 including a radio frequency module 31 including the radio frequency switching circuit 1 will be described with reference to FIG. 1.

As illustrated in FIG. 1, the communication apparatus 30 is a communication apparatus including the radio frequency module 31. The communication apparatus 30 is, for example, a mobile terminal (for example, a smartphone) but is not limited to the mobile terminal. The communication apparatus 30 may be, for example, a wearable terminal (for example, a smart watch). The radio frequency module 31 is a module that is allowed to support, for example, the 4G (fourth-generation mobile communication) standard and the 5G (fifth-generation mobile communication) standard. Examples of the 4G standard include Third Generation Partnership Project (3GPP) (registered trademark) and the LTE standard. Examples of the 5G standard include 5G new radio (NR).

The communication apparatus 30 further includes a signal processing circuit 32 and an antenna 33 in addition to the radio frequency module 31.

The radio frequency module 31 is configured to amplify a reception signal (radio frequency signal) received at the antenna 33 and output the amplified signal to the signal processing circuit 32. The radio frequency module 31 is configured to amplify a transmission signal (radio frequency signal) output from the signal processing circuit 32 and transmit the amplified signal from the antenna 33. The radio frequency module 31 is controlled by, for example, the signal processing circuit 32.

The signal processing circuit 32 is connected to the radio frequency module 31 and is configured to perform signal processing of the reception signal output from the radio frequency module 31. The signal processing circuit 32 is also configured to perform signal processing of the transmission signal to be output to the radio frequency module 31. The signal processing circuit 32 includes a radio frequency (RF) signal processing circuit 35 and a baseband signal processing circuit 34.

The RF signal processing circuit 35 is, for example, a radio frequency integrated circuit (RFIC) and performs signal processing of radio frequency signals (a transmission signal and a reception signal). The RF signal processing circuit 35 performs signal processing such as downconverting of the reception signal output from the radio frequency module 31 and outputs the reception signal to the baseband signal processing circuit 34. The RF signal processing circuit 35 also performs signal processing such as upconverting of the transmission signal output from the baseband signal processing circuit 34 and outputs the transmission signal to the radio frequency module 31.

The baseband signal processing circuit 34 is, for example, a baseband integrated circuit (BBIC). The baseband signal processing circuit 34 outputs, to the outside, the reception signal output from the RF signal processing circuit 35. The output signal (reception signal) is usable, for example, for image display, as an image signal or calling as an audio signal. The baseband signal processing circuit 34 also generates a transmission signal from the baseband signal (for example, an audio signal or an image signal) and outputs the generated transmission signal to the RF signal processing circuit 35.

### 1-3 Example Configuration of Radio Frequency Module

As illustrated in FIG. 1, the radio frequency module 31 includes the radio frequency switching circuit 1, one or more (in the example in FIG. 1, two) reception components 50 (electronic components), one or more (in the example in FIG. 1, two) transmission components 51 (electronic components), and a plurality of external terminals 40a to 40c.

The reception component 50 is an electronic component used for processing the reception signal. In the example in FIG. 1, the one or more reception components 50 are a reception filter 36 and a low-noise amplifier 38. The one or more reception components 50 are connected between the first input/output terminal 3 and the external terminal 40b.

The transmission component 51 is an electronic component used for processing the transmission signal. In the example in FIG. 1, the one or more transmission components 51 are a transmission filter 37 and a power amplifier 39. The one or more transmission components 51 are connected between a second input/output terminal 4 and the external terminal 40c.

The external terminal 40a is an antenna terminal connected to the antenna 33. The external terminal 40b is connected to an input part (not illustrated) of the signal processing circuit 32 and is an output terminal that outputs the reception signal processed in the radio frequency module 31 to the input part of the signal processing circuit 32. The external terminal 40c is connected to the output part (not illustrated) of the signal processing circuit 32 and is an input terminal that inputs the transmission signal processed in the signal processing circuit 32 to the radio frequency module 31.

The radio frequency switching circuit 1 is, for example, an antenna switch. The radio frequency switching circuit 1, the radio frequency switching circuit 1 has the common terminal 2, the plurality of (in the example in FIG. 2, two) input/output terminals (the first input/output terminal 3 and the second input/output terminal 4). Each input/output terminal is also referred to as a selection terminal. The common terminal 2 is selectively connected to one of the first input/output terminal 3 and the second input/output terminal 4. The common terminal 2 is connected to the external terminal 40a (antenna terminal). The first input/output terminal 3 is connected to the external terminal 40b with the one or more reception components 50 interposed therebetween. The second input/output terminal 4 is connected to the external terminal 40c with the one or more transmission components 51 interposed therebetween.

The reception filter 36 has an input part 36a and an output part 36b. The input part 36a is connected to the first input/output terminal 3 of the radio frequency switching circuit 1. The output part 36b is connected to an input part 38a of the low-noise amplifier 38. The reception filter 36 receives a signal (reception signal) from the input part 36a, allows the signal input and limited to one in a reception band serving as a first communication band to pass, and outputs, from the output part 36b, the signal allowed to pass.

The transmission filter 37 has an input part 37a and an output part 37b. The input part 37a is connected to an output part 39b of the power amplifier 39. The output part 37b is connected to the second input/output terminal 4 of the radio frequency switching circuit 1. The transmission filter 37 receives a signal (transmission signal) from the input part 37a, allows the signal input and limited to one in a transmission band serving as a second communication band, and outputs, from the output part 37b, the signal allowed to pass. The second communication band may be the same communication band as the first communication hand and may also be a communication band different from the first communication band.

The low-noise amplifier 38 has the input part 38a and an output part 38b. The input part 38a is connected to the output part 36b of the reception filter 36. The output part 38b is connected to the external terminal 40b. The low-noise amplifier 38 amplifies a signal (reception signal) input to the input part 38a and outputs the amplified signal from the output part 38b.

The power amplifier 39 has an input part 39a and the output part 39b. The input part 39a is connected to the external terminal 40c. The output part 39b is connected to the input part 37a of the transmission filter 37. The power amplifier 39 amplifies a signal (transmission signal) input to the input part 39a and outputs the amplified signal from the output part 39b.

### 1-4 Configuration of Radio Frequency Switching Circuit

The configuration of the radio frequency switching circuit 1 will be described in detail with reference to FIG. 2. As illustrated in FIG. 2, the radio frequency switching circuit 1 further includes the first serial FET 5, the first parallel FET 6, a second serial FET 7, a second parallel FET 8, a third parallel FET 9 (parallel FET), the voltage source 10, the charge pump 11, the voltage supply path 12, first to fifth level shifters 13 to 17, resistors R1 to R5, the first switch SW1, and the second switch SW2 in addition to the common terminal 2, the first input/output terminal 3, and the second input/output terminal 4 that are described above. Note that the voltage source 10 does not have to be included in the configuration of the radio frequency switching circuit 1.

As described above, the common terminal 2 is connected to the external terminal 40a (see FIG. 1).

As described above, the first input/output terminal 3 is connected to the external terminal 40b (see FIG. 1) with the one or more reception components 50 (see FIG. 1) interposed therebetween. The first input/output terminal 3 is also connected to the common terminal 2 with the first signal path L1 interposed therebetween.

As described above, the second input/output terminal 4 is connected to the external terminal 40c (see FIG. 1) with the one or more transmission components 51 (with reference) interposed therebetween. The second input/output terminal 4 is also connected to the common terminal 2 with a second signal path L2 interposed therebetween.

The first serial FET 5 is, for example, an N-channel enhancement-mode MOSFET. The first serial FET 5 is connected in series to the first signal path L1. The first serial FET 5 is thus connected to the common terminal 2 and the first input/output terminal 3 on the first signal path L1. Switching between on and off of the first serial FET 5 causes the first signal path L1 to turn on or off. The first serial FET 5 has the control electrode (for example, a gate), a first main electrode (for example, a drain), and a second main electrode (for example, a source). The first signal path L1 has signal paths L11 and L12. The first main electrode of the first serial FET 5 is connected to the common terminal 2 with the signal path L11 interposed therebetween. The second main electrode of the first serial FET 5 is connected to the first input/output terminal 3 with the signal path L12 interposed therebetween. The control electrode of the first serial FET 5 is indirectly connected to the connection node N1 with the resistor R1 and the first level shifter 13 interposed therebetween.

The first parallel FET 6 is, for example, an N-channel enhancement-mode MOSFET. The first parallel FET 6 is connected between ground and the signal path L12 between the first input/output terminal 3 and the first serial FET 5, and switching between on and off of the first parallel FET 6 causes a section between the ground and the signal path L12 to turn on or off. The first parallel FET 6 has a control electrode (for example, a gate), a first main electrode (for example, a drain), and a second main electrode (for example, a source). The first main electrode of the first parallel FET 6 is connected to a connection node N2 provided on the signal path L12. The second main electrode of the first parallel FET 6 is connected to ground. The control electrode of the first parallel FET 6 is indirectly connected to the connection node N1 with the resistor R2 and the second level shifter 14 interposed therebetween.

The second serial FET 7 is, for example, an N-channel enhancement-mode MOSFET. The second serial FET 7 is connected in series to the second signal path L2. The second serial FET 7 is thus connected to the common terminal 2 and the second input/output terminal 4 on the second signal path L2. Switching between on and off of the second serial FET 7 causes the second signal path L2 to turn on or off. The second serial FET 7 has a control electrode (for example, a gate), a first main electrode (for example, a drain), and a second main electrode (for example, a source). The second signal path L2 has signal paths L21 and L12. The first main electrode of the second serial FET 7 is connected to the common terminal 2 with the signal path L21 interposed therebetween. The second main electrode of the second serial FET 7 is connected to the second input/output terminal 4 with the signal path L22 interposed therebetween. The control electrode of the second serial FET 7 is indirectly connected to the connection node N1 with the resistor R3 and the first level shifter 15 interposed therebetween.

The second parallel FET 8 is, for example, an N-channel enhancement-mode MOSFET. The second parallel FET 8 is connected between ground and the signal path L22 between the second input/output terminal 4 and the second serial FET 7, and switching between on and off of the second parallel FET 8 causes a section between ground and the signal path L22 to turn on or off. The second parallel FET 8 has a control electrode (for example, a gate), a first main electrode (for example, a drain), and a second main electrode (for example, a source). The first main electrode of the second parallel FET 8 is connected to a connection node N3 provided on the signal path L22. The second main electrode of the second parallel FET 8 is connected to ground. The control electrode of the second parallel FET 8 is indirectly connected to the connection node N1 with the resistor R4 and the fourth level shifter 16 interposed therebetween.

The third parallel FET 9 is, for example, an N-channel enhancement-mode MOSFET. The third parallel FET 9 is connected to the common terminal 2, and switching between on and off of the third parallel FET 9 causes a section between ground and the common terminal 2 to turn on or off. The third parallel FET 9 has a control electrode (for example, a gate), a first main electrode (for example, a drain), and a second main electrode (for example, a source). The first main electrode of the third parallel FET 9 is connected to a connection node N5 provided on a signal path L3. In the example in FIG. 1, the signal path L3 included in the signal path L11 and between the common terminal 2 and a connection node N4 and the signal path L3 included in the signal path L21 and between the common terminal 2 and the connection node N4 form a common signal path. The second main electrode of the third parallel FET 9 is connected to ground. The control electrode of the third parallel FET 9 is indirectly connected to the connection node N1 with the resistor R5 and the fifth level shifter 17 interposed therebetween.

In the following description, when not being discriminated from each other, the first serial FET 5, the first parallel FET 6, the second serial FET 7, the second parallel FET 8, and the third parallel FET 9 are simply referred to as the FETs 5 to 9 on occasions.

The voltage source 10 outputs a power supply voltage that is constant. The voltage source 10 outputs the power supply voltage based on a power supply voltage from a power supply circuit (not illustrated). The voltage source 10 has the first output part 10a and the second output part 10b. The first output part 10a is connected to an end of the voltage supply path 12. The second output part 10b is connected to an input part 11a of the charge pump 11. The voltage source 10 applies, to the voltage supply path 12, the power supply voltage output from the first output part 10a. The voltage source 10 also inputs, to the input part 11a of the charge pump 11, the power supply voltage output from the second output part 10b.

Based on the power supply voltage input from the voltage source 10, the charge pump 11 supplies a positive voltage and a negative voltage as control electrodes for controlling the FETs 5 to 9. In the example in FIG. 2, the charge pump 11 supplies the control voltages to first input parts 13a to 17a of the respective first to fifth level shifters 13 to 17. The positive voltage is a control voltage for switching any of the FETs 5 to 9 to on. The negative voltage is a control voltage for switching any of the FETs 5 to 9 to off.

In more detail, the charge pump 11 has the input part 11a, the first output part 11b, and a second output part 11c.

The input part 11a is connected to the second output part 10b of the voltage source 10 and receives the power supply voltage from the voltage source 10.

The first output part 11b is connected to the connection node N1 with the first path M1 interposed therebetween. The first switch SW1 (described later) is provided on the first path M1. The connection node N1 is connected to the first input parts 13a to 17a of the respective first to fifth level shifters 13 to 17. The first output part 11b is thus connected to the first input parts 13a to 17a of the respective first to fifth level shifters 13 to 17 with the first switch SW1 interposed therebetween. Further, the first to fifth level shifters 13 to 17 are provided for the FETs 5 to 9 on a one-to-one correspondence. Specifically, the first level shifter 13, the second level shifter 14, the third level shifter 15, the fourth level shifter 16, and the fifth level shifter 17 are respectively provided for the first serial FET 5, the first parallel FET 6, the second serial FET 7, the second parallel FET 8, and the parallel FET 9. Output parts 13c to 17c of the respective first to fifth level shifters 13 to 17 are connected to the control electrodes of the corresponding FETs 5 to 9. The first output part 11b is thus indirectly connected to the control electrodes of the corresponding FETs 5 to 9 with the first switch SW1 and the corresponding first to fifth level shifters 13 to 17. The second output part 11c is connected to second input parts 13b to 17b of the respective first to fifth level shifters 13 to 17. The charge pump 11 increases the power supply voltage input to the input part 11a to generate a positive voltage and outputs the generated positive voltage from the first output part 11b. The charge pump 11 generates a negative voltage, for example, by inverting the generated positive voltage and outputs the generated negative voltage from the second output part 11c.

The voltage supply path 12 connects the first output part 10a of the voltage source 10 and the connection node N1. The power supply voltage output from the first output part 10a of the voltage source 10 has been applied to the voltage supply path 12. The second switch SW2 (described later) is provided on the voltage supply path 12. As described above, the connection node N1 is connected to the first input parts 13a to 17a of the respective first to fifth level shifters 13 to 17. The voltage supply path 12 is thus used to supply the power supply voltage to the second switch SW2 via the first input parts 13a to 17a of the respective first to fifth level shifters 13 to 17.

The first switch SW1 is provided on the first path M1 and turns the first path M1 on and off. The first switch SW1 is switchable selectively to one of on and off in accordance with a control signal from a controller (not illustrated). The first switch SW1 causes the first path M1 to turn on upon being switched to on and causes the first path M1 to turn off upon being switched to off. Turning the first path M1 on or off by the first switch SW1 causes switching to be selectively performed between the supplying and the stopping of the positive voltage from the first output part 11b of the charge pump 11 to the first input parts 13a to 17a of the first to fifth level shifters 13 to 17.

The second switch SW2 is provided on the voltage supply path 12 and turns the voltage supply path 12 on and off. The second switch SW2 is switchable selectively to one of on and off in accordance with a control signal from the controller (not illustrated). The second switch SW2 causes the voltage supply path 12 to turn on upon being switched to on and causes the voltage supply path 12 to turn off upon being switched to off. Turning the voltage supply path 12 on or off by the second switch SW2 causes switching to be selectively performed between the supplying and the stopping of the positive voltage from the first output part 10a of the voltage source 10 to the first input parts 13a to 17a of the first level shifters 13 to 17.

The radio frequency switching circuit 1 has a plurality of operation modes including a transmission/reception mode and a low power-consumption mode. The transmission/reception mode is a mode in which the communication apparatus 30 including the radio frequency switching circuit 1 performs transmission and reception. The low power-consumption mode is a mode in which the communication apparatus 30 is in a standby state without performing transmission and reception. In the low power-consumption mode, the charge pump is stopped. In the transmission/reception mode, switching of the first switch SW1 to on and switching the second switch SW2 to off cause, to be applied to the connection node N1, the output voltage of the first output part 11b of the charge pump 11. In the low power-consumption mode, switching of the first switch SW1 to off and switching of the second switch SW2 to on cause, to be applied to the connection node N1, the power supply voltage applied to the voltage supply path 12.

The first level shifter 13 has the first input part 13a, the second input part 13b, the output part 13c (a first output part), and a control signal input part 13d. The first input part 13a is connected to the connection node N1 and receives the voltage (the positive voltage or the power supply voltage) applied to the connection node N1. The second input part 13b is connected to the second output part 11c of the charge pump 11 and receives the output voltage (negative voltage) of the second output part 11c. The control signal input part 13d selectively receives one of a high-level signal and a low-level signal as the control signal from the controller (not illustrated). The output part 13c is connected to the control electrode of the first serial FET 5 with the resistor R1 interposed therebetween. In accordance with the control signal input to the control signal input part 13d, the first level shifter 13 selectively outputs, from the output part 13c, one of the voltage (the positive voltage or the power supply voltage) input to the first input part 13a and the voltage (negative voltage) input to the second input part 13b. For example, if a high-level signal is input to the control signal input part 13d, the first level shifter 13 outputs, from the output part 13c, the voltage input to the first input part 13a. If a low-level signal is input to the control signal input part 13d, the first level shifter 13 outputs, from the output part 13c, the voltage input to the second input part 13b. The output voltage of the output part 13c is applied to the control electrode of the first serial FET 5, and switching between on and off of the first serial FET 5 is performed.

The second level shifter 14 has the first input part 14a (a third input part), the second input part 14b (a fourth input part), the output part 14c (a second output part), and a control signal input part 14d. The first input part 14a (third input part) is connected to the connection node N1 and receives the voltage (the positive voltage or the power supply voltage) applied to the connection node N1. The second input part 14b (fourth input part) is connected to the second output part 11c of the charge pump 11 and receives the output voltage of the second output part 11c (negative voltage). The control signal input part 14d selectively receives one of a high-level signal and a low-level signal as a control signal from the controller (not illustrated). The output part 14c is connected to the control electrode of the first parallel FET 6 with the resistor R2 interposed therebetween. In accordance with the control signal input to the control signal input part 14d, the second level shifter 14 selectively outputs, from the output part 14c, one of the voltage (the positive voltage or the power supply voltage) input to the first input part 14a and the voltage (negative voltage) input to the second input part 14b. For example, if the high-level signal is input to the control signal input part 14d, the second level shifter 14 outputs, from the output part 14c, the voltage input to the first input part 14a. If the low-level signal is input to the control signal input part 14d, the second level shifter 14 outputs, from the output part 14c, the voltage input to the second input part 14b. The output voltage of the output part 14c is applied to the control electrode of the first parallel FET 6, and switching between on and off of the first parallel FET 6 is performed.

The third level shifter 15 has the first input part 15a, the second input part 15b, the output part 15c, and a control signal input part 15d. The first input part 15a is connected to the connection node N1 and receives the voltage (the positive voltage or the power supply voltage) applied to the connection node N1. The second input part 15b is connected to the second output part 11c of the charge pump 11 and receives the output voltage (negative voltage) of the second output part 11c. The control signal input part 15d selectively receives one of a high-level signal and a low-level signal as a control signal from the controller (not illustrated). The output part 15c is connected to the control electrode of the second serial FET 7 with the resistor R3 interposed therebetween. In accordance with the control signal input to the control signal input part 15d, the third level shifter 15 selectively outputs, from the output part 15c, one of the voltage (the positive voltage or the power supply voltage) input to the first input part 15a and the voltage (negative voltage) input to the second input part 15b. For example, if the high-level signal is input to the control signal input part 15d, the third level shifter 15 outputs, from the output part 15c, the voltage input to the first input part 14a. If the low-level signal is input to the control signal input part 15d, the third level shifter 15 outputs, from the output part 15c, the voltage input to the second input part 14b. The output voltage of the output part 15c is applied to the control electrode of the second serial FET 7, and switching between on and off of the second serial FET 7 is performed.

The fourth level shifter 16 has the first input part 16a, the second input part 16b, the output part 16c, and a control signal input part 16d. The first input part 16a is connected to the connection node N1 and receives the voltage (the positive voltage or the power supply voltage) applied to the connection node N1. The second input part 16b is connected to the second output part 11c of the charge pump 11 and receives the output voltage (negative voltage) of the second output part 11c. The control signal input part 16d selectively receives one of a high-level signal and a low-level signal as a control signal from the controller (not illustrated). The output part 16c is connected to the control electrode of the second parallel FET 8 with the resistor R4 interposed therebetween. In accordance with the control signal input to the control signal input part 16d, the fourth level shifter 16 selectively outputs, from the output part 16c, one of the voltage (the positive voltage or the power supply voltage) input to the first input part 16a and the voltage (negative voltage) input to the second input part 16b. For example, if the high-level signal is input to the control signal input part 16d, the fourth level shifter 16 outputs, from the output part 16c, the voltage input to the first input part 16a. If the low-level signal is input to the control signal input part 16d, the fourth level shifter 16 outputs, from the output part 16c, the voltage input to the second input part 16b. The output voltage of the output part 16c is applied to the control electrode of the second parallel FET 8, and switching between on and off of the second parallel FET 8 is performed.

The fifth level shifter 17 has the first input part 17a, the second input part 17b, the output part 17c, and a control signal input part 17d. The first input part 17a is connected to the connection node N1 and receives the voltage (the positive voltage or the power supply voltage) applied to the connection node N1. The second input part 17b is connected to the second output part 11c of the charge pump 11 and receives the output voltage (negative voltage) of the second output part 11c. The control signal input part 17d selectively receives one of a high-level signal and a low-level signal as a control signal from the controller (not illustrated). The output part 17c is connected to the control electrode of the third parallel FET 9 with the resistor R5 interposed therebetween. In accordance with the control signal input to the control signal input part 17d, the fifth level shifter 17 selectively outputs, from the output part 17c, one of the voltage (the positive voltage or the power supply voltage) input to the first input part 17a and the voltage (negative voltage) input to the second input part 17b. For example, if the high-level signal is input to the control signal input part 17d, the fifth level shifter 17 outputs, from the output part 17c, the voltage input to the first input part 17a. If the low-level signal is input to the control signal input part 17d, the fifth level shifter 17 outputs, from the output part 17c, the voltage input to the second input part 17b. The output voltage of the output part 17c is applied to the control electrode of the third parallel FET 9, and switching between on and off of the third parallel FET 9 is performed.

### 1-5 Operations of Radio Frequency Switching Circuit

The operations of the radio frequency switching circuit 1 will be described with reference to FIG. 2.

### 1-5-1 Operations in Transmission Mode

In the transmission/reception mode, the charge pump 11 operates to generate a positive voltage and a negative voltage, outputs the generated positive voltage from the first output part 11b, and outputs the generated negative voltage from the second output part 11c. In the transmission/reception mode, the first switch SW1 is switched to on, and the second switch SW2 is switched to off. Accordingly, the output voltage (power supply voltage) of the first output part 10a of the voltage source 10 is not applied to the connection node N1, and the output voltage (positive voltage) of the first output part 11b of the charge pump 11 is applied to the connection node N1. The first input parts 13a to 17a of the first to fifth level shifters 13 to 17 thereby receive the output voltage (positive voltage) of the first output part 11b of the charge pump 11. The second input parts 13b to 17b of the first to fifth level shifters 13 to 17 receives the output voltage (negative voltage) of the second output part 11c of the charge pump 11.

In a case where the common terminal 2 is selectively connected to the first input/output terminal 3, the first serial FET 5 of the FETs 5 to 9 is switched to on, and the remaining FETs 6 to 9 are switched to off. That is, the control signal input part 13d of the first level shifter 13 receives the high-level signal, and the control signal input parts 14d to 17d of the second to fifth level shifters 14 to 17 receive the low-level signal. Accordingly, the first serial FET 5 is switched to on, and the remaining FETs 6 to 9 are switched to off. As the result, the common terminal 2 is selectively connected to the first input/output terminal 3. That is, the first signal path L1 between the common terminal 2 and the first input/output terminal 3 turns on, and the second signal path L2 between the common terminal 2 and the second input/output terminal 4 turns off.

In a case where the common terminal 2 is selectively connected to the second input/output terminal 4, the second serial FET 7 of the FETs 5 to 9 is switched to on, and the remaining FETs 5, 6, 8, and 9 are switched to off. That is, the control signal input part 15d of the third level shifter 15 receives the high-level signal, and the control signal input parts 13d, 14d, 16d, and 17d of the first, second, fourth, and fifth level shifters 13, 14, 16, and 17 receive the low-level signal. Accordingly, the second serial FET 7 is switched to on, and the remaining FETs 5, 6, 8, and 9 are switched to off. As the result, the common terminal 2 is selectively connected to the second input/output terminal 4. That is, the second signal path L2 between the common terminal 2 and the second input/output terminal 4 turns on, and the first signal path L1 between the common terminal 2 and the first input/output terminal 3 turns off.

### 1-5-2 Operations in Low Power-Consumption Mode

In the low power-consumption mode, the charge pump 11 is stopped, does not generate the positive voltage and the negative voltage, and outputs a voltage close to zero volts from the first output part 11b and the second output part 11c. In the low power-consumption mode, the first switch SW1 is switched to off, and the second switch SW2 is switched to on. Accordingly, the output voltage (voltage close to zero volts) of the first output part 11b of the charge pump 11 is not applied to the connection node N1, and the output voltage (power supply voltage) of the first output part 10a of the voltage source 10 is applied to the connection node N1. The first input parts 13a to 17a of the first to fifth level shifters 13 to 17 thereby receive the output voltage (power supply voltage) of the first output part 10a of the voltage source 10. The second input parts 13b to 17b of the first to fifth level shifters 13 to 17 receive the output voltage (voltage close to zero volts) of the second output part 11c of the charge pump 11.

In the low power-consumption mode, all of the FETs 5 to 9 are switched to on. The control signal input parts 13d to 15d of the first to fifth level shifters 13 to 17 thus receive the high-level signal. Accordingly, the output voltage (power supply voltage) of the voltage source 10 applied to the voltage supply path 12 is applied to the control electrodes of the FETs 5 to 9, and the FETs 5 to 9 are switched to on. In the on state, the FETs 5 to 9 have been switched to on due to the power supply voltage and thus have a sufficiently low ON resistance in the on state. Accordingly, in the low power-consumption mode, if a radio frequency signal transmitted from the external terminal apparatus present nearby enters the radio frequency switching circuit 1, the generation of a reflected wave of the radio frequency signal in the radio frequency switching circuit 1 may be reduced. As the result, returning of the generated reflected wave to the external terminal apparatus may be reduced.

### 1-5-3 Explanation of Reduction in Reflected Wave of Radio Frequency Signal in Radio Frequency Switching Circuit

If an external terminal apparatus is present near the communication apparatus 30 including the radio frequency switching circuit 1, a radio frequency signal transmitted from an external terminal apparatus enters the communication apparatus 30 (that is, the radio frequency switching circuit 1) through the antenna 33 of the communication apparatus 30 on occasions. Suppose a case where a radio frequency signal transmitted from the external terminal apparatus enters the radio frequency switching circuit 1 when the communication apparatus 30 is in the low power-consumption mode. In this case, in the low power-consumption mode as described above, the power supply voltage is applied to the control electrodes of the FETs 5 to 9, and thus the FETs 5 to 9 have a sufficiently low ON resistance in the on state. The FETs 5 to 9 may be considered to have substantially no ON resistance. Accordingly, in the low power-consumption mode, when the incoming radio frequency signal from the external terminal apparatus passes through the FETs 5 to 9, almost no distortion (reflected wave) due to the ON resistance of the FETs 5 to 9 is generated. That is, almost no reflected wave of the radio frequency signal is generated because the FETs 5 to 9 have the sufficiently low ON resistance.

Most of incoming radio frequency signals into the radio frequency switching circuit 1 flow from the common terminal 2 to ground via the third parallel FET 9, and thus the strength of the remaining radio frequency signals is sufficiently low. Accordingly, even though the remaining radio frequency signals generate reflected waves, the strength of the reflected waves is sufficiently low. A radio frequency signal passing through the first signal path L1 flows to ground via the first serial FET 5 and the first parallel FET 6, and thus almost no reflected wave is generated from the radio frequency signal. Likewise, a radio frequency signal passing through the second signal path L2 flows to ground via the second serial FET 7 and the second parallel FET 8, and thus almost no reflected wave is generated from the radio frequency signal. In the low power-consumption mode, the reflected wave of the radio frequency signal is thus reduced in the radio frequency switching circuit 1. As the result, deterioration of the receiver sensitivity of the external terminal apparatus may be reduced, the deterioration being caused by the returning of the reflected wave to the external terminal apparatus.

### 1-6 Comparative Example

A radio frequency switching circuit in a comparative example (hereinafter, simply referred to as Comparative Example) will be described. Comparative Example is different from the radio frequency switching circuit 1 in Exemplary Embodiment 1 in that the voltage supply path 12, the first switch SW1, and the second switch SW2 are omitted. Accordingly, in Comparative Example, regardless of the transmission/reception mode or the low power-consumption mode, the output voltage of the first output part 11b of the charge pump 11 is input to the first input parts 13a to 17a of the first to fifth level shifters 13 to 17. In the low power-consumption mode, the charge pump 11 is stopped. Accordingly, the positive voltage and the negative voltage are not generated, and the output voltages of the first output part 11b and the second output part 11c of the charge pump 11 become voltages close to zero volts. In Comparative Example, in the low power-consumption mode, the output voltage of the first output part 11b of the charge pump 11 causes all of the FETs 5 to 9 to switch to on.

However, in Comparative Example, in the low power-consumption mode, a voltage close to zero volts, instead of the positive voltage, is applied from the output parts 13c to 17c of the first to fifth level shifters 13 to 17 to the control electrodes of the FETs 5 to 9. Accordingly, the FETs 5 to 9 of Comparative Example are not allowed to switch to on sufficiently, and a high ON resistance to some extent is generated in the on state. If a radio frequency signal transmitted from the external terminal apparatus enters the radio frequency switching circuit of Comparative Example in this state, the high ON resistance to some extent causes distortion (that is, reflected wave) to be generated when the incoming radio frequency signal flow through the FETs 5 to 9. The generated reflected wave returns to the external terminal apparatus and causes the receiver sensitivity of the external terminal apparatus to be deteriorated. In contrast, as described above, the radio frequency switching circuit 1 in Exemplary Embodiment 1 may reduce the reflected wave and thus reduce the deterioration of the receiver sensitivity of the external terminal apparatus.

### 1-7 Advantageous Effects

The radio frequency switching circuit 1 according to Exemplary Embodiment 1 includes the common terminal 2, the first input/output terminal 3, the first serial FET 5, the first parallel FET 6, the charge pump 11, the voltage source 10, the voltage supply path 12, the first switch SW1, and the second switch SW2. The first input/output terminal 3 is connected to the common terminal 2 with the first signal path L1 interposed therebetween. The first serial FET 5 is connected to the common terminal 2 and the first input/output terminal 3 on the first signal path L1. The first parallel FET 6 is connected between ground and the signal path L12 between the first input/output terminal 3 and the first serial FET 5. The charge pump 11 has the first output part 11b (output part). The charge pump 11 supplies, from the first output part 11b, the control voltage for controlling the first serial FET 5 and the control voltage for controlling the first parallel FET 6. The voltage source 10 has the first output part 10a and the second output part 10b that supply respective voltages. The voltage source 10 supplies a voltage from the second output part 10b to the charge pump 11. The voltage supply path 12 connects the first output part 10a of the voltage source 10 and the connection node N1 connected to the control electrode of the first serial FET 5. The first switch SW1 is provided on the first path M1 connecting the first output part 11b of the charge pump 11 and the connection node N1 and turns the first path M1 on and off. The second switch SW2 is provided on the voltage supply path 12 and turns the voltage supply path 12 on and off.

With this configuration, in the state where the charge pump 11 is stopped, the first switch SW1 causes the first path M1 to turn off, and the second switch SW2 causes the voltage supply path 12 to turn on. Applying, to the control electrode of the first serial FET 5, the voltage (for example, the power supply voltage) applied to the voltage supply path 12 may thereby cause the state of the first serial FET 5 to switch to the on state where the ON resistance is sufficiently low. Accordingly, the generation of the reflected wave of the radio frequency may be reduced, the generation being caused by the ON resistance of the first serial FET 5 when the radio frequency signal having entered the common terminal 2 from the external terminal apparatus passes through the first serial FET 5 in the state the charge pump 11 is stopped. As the result, the deterioration of the receiver sensitivity of the external terminal apparatus may be reduced, the deterioration being caused by the returning of the reflected wave to the external terminal apparatus.

In the radio frequency switching circuit 1 according to Exemplary Embodiment 1, the control electrode of the first parallel FET 6 is operatively connected the connection node N1 (the connection node N1 in the example in FIG. 2).

With this configuration, in the state where the charge pump 11 is stopped, the first switch SW1 causes the first path M1 to turn off, and the second switch SW2 causes the voltage supply path 12 to turn on. The voltage (for example, the power supply voltage) applied to the voltage supply path 12 may thereby further be applied to the control electrode of the first parallel FET 6, and further, the state of the first parallel FET 6 may be switched to the on state where the ON resistance is sufficiently low. Accordingly, the generation of the reflected wave may be reduced, the generation being caused by the ON resistance of the first parallel FET 6 when the radio frequency signal having entered the common terminal 2 from the external terminal apparatus passes through the first parallel FET 6 in the state the charge pump 11 is stopped. Further, the radio frequency signal may be made flow to ground. As the result, the deterioration of the receiver sensitivity of the external terminal apparatus may further be reduced, the deterioration being caused by the returning of the reflected wave to the external terminal apparatus.

The radio frequency switching circuit 1 according to Exemplary Embodiment 1 further includes the second input/output terminal 4, the second serial FET 7, and the second parallel FET 8. The second input/output terminal 4 is connected to the common terminal 2 with the second signal path L2 interposed therebetween. The second serial FET 7 is connected to the common terminal 2 and the second input/output terminal 4 on the second signal path L2. The second parallel FET 8 is connected between ground and the signal path L22 between the second input/output terminal 4 and the second serial FET 7. The connection node N1 is further connected to the control electrode of the second serial FET 7.

With this configuration, also for the second serial FET 7 provided on the second signal path L2, likewise in the first serial FET 5, the generation of the reflected wave may be reduced, the generation being caused by the ON resistance of the second serial FET 7 when the radio frequency signal having entered the common terminal 2 from the external terminal apparatus passes through the second serial FET 7 in the state the charge pump 11 is stopped. As the result, the deterioration of the receiver sensitivity of the external terminal apparatus may further be reduced, the deterioration being caused by the returning of the reflected wave to the external terminal apparatus.

In the radio frequency switching circuit 1 according to Exemplary Embodiment 1, the charge pump 11 supplies the control voltages for controlling the respective FETs 5 to 9, based on the voltage (for example, the power supply voltage) from the voltage source 10. With this configuration, the voltage source 10 for the voltage supply path 12 may also serve as a voltage source for the charge pump 11. As the result, the radio frequency switching circuit 1 may be downsized.

The radio frequency switching circuit 1 according to Exemplary Embodiment 1 further includes the third parallel FET 9 (parallel FET). The third parallel FET 9 is connected between the common terminal 2 and ground.

With this configuration, also for the third parallel FET 9 connected between the common terminal 2 and ground, likewise in the first serial FET 5, the generation of the reflected wave may be reduced, the generation being caused by the ON resistance of the third parallel FET 9 when the radio frequency signal having entered the common terminal 2 from the external terminal apparatus passes through the third parallel FET 9 in the state the charge pump 11 is stopped. Further, the radio frequency signal may be made flow to ground. As the result, the deterioration of the receiver sensitivity of the external terminal apparatus may further be reduced, the deterioration being caused by the returning of the reflected wave to the external terminal apparatus.

The radio frequency switching circuit 1 according to Exemplary Embodiment 1 further includes the first level shifter 13 and the second level shifter 14. The first level shifter 13 controls the first serial FET 5. The second level shifter 14 controls the first parallel FET 6. The first level shifter 13 has the first input part 13a, the second input part 13b, and the output part 13c (first output part). The first input part 13a is connected to the connection node N1. The second input part 13b is connected to the charge pump 11 (a negative voltage supply circuit). The output part 13c is connected to the control electrode of the first serial FET 5 and selectively outputs the voltage input to the first input part 13a or the voltage input to the second input part 13b. The second level shifter 14 has the first input part 14a (third input part), the second input part 14b (fourth input part), and the output part 14c (second output part). The first input part 14a is connected to a path M1a or the connection node N1 (to the connection node N1 in Exemplary Embodiment 1). The path M1a is a path between the first output part 11b (output part) of the charge pump 11 and the first switch SW1. The second input part 14b is connected to the charge pump 11 (negative voltage supply circuit). The output part 14c is connected to the control electrode of the first parallel FET 6 and selectively outputs the voltage input to the first input part 14a or the voltage input to the second input part 14b.

With this configuration, even in the case where the radio frequency switching circuit 1 includes the first level shifter 13 and the second level shifter 14, the generation of the reflected wave may be reduced, the generation being caused by the ON resistance of a FET when a radio frequency signal having entered from the external terminal apparatus to the common terminal 2 passes through the FET (at least the first serial FET 5 (the first serial FET 5 and the first parallel FET 6 in Exemplary Embodiment 1) of the first serial FET 5 and the first parallel FET 6) in the state where the charge pump 11 is stopped. As the result, the deterioration of the receiver sensitivity of the external terminal apparatus may be reduced, the deterioration being caused by the returning of the reflected wave to the external terminal apparatus.

The radio frequency module 31 according to Exemplary Embodiment 1 includes the radio frequency switching circuit 1 and the electronic component 50. The electronic component 50 is connected between the first input/output terminal 3 of the radio frequency switching circuit 1 and the external terminal 40b. With this configuration, the radio frequency module 31 that exerts the effect of the radio frequency switching circuit 1 may be provided.

The communication apparatus 30 according to Exemplary Embodiment 1 includes the radio frequency module 31 and the signal processing circuit 32. The signal processing circuit 32 is connected to the radio frequency module 31 and performs signal processing of a radio frequency signal. With this configuration, the communication apparatus 30 that exerts the effect of the radio frequency switching circuit 1 may be provided.

### 1-8 Modification

A modification of Exemplary Embodiment 1 will be described.

In Exemplary Embodiment 1, the case where the one or more reception components 50 are connected between the first input/output terminal 3 and the external terminal 40b and the one or more transmission components 51 are connected between the second input/output terminal 4 and the external terminal 40c are exemplified. However, the one or more transmission components 51 may be connected between the first input/output terminal 3 and the external terminal 40b, and the one or more reception components 50 may be connected between the second input/output terminal 4 and the external terminal 40c. In this case, the external terminal 40b serves as an input terminal that inputs the transmission signal processed in the signal processing circuit 32 to the radio frequency module 31, and the external terminal 40c serves as an output terminal that outputs the reception signal processed in the radio frequency module 31 to the input part of the signal processing circuit 32.

### 2 Exemplary Embodiment 2

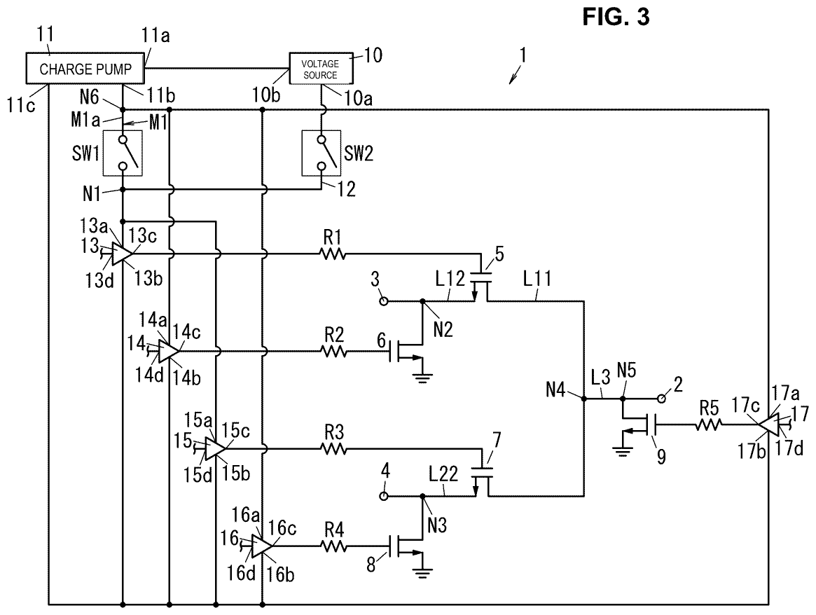

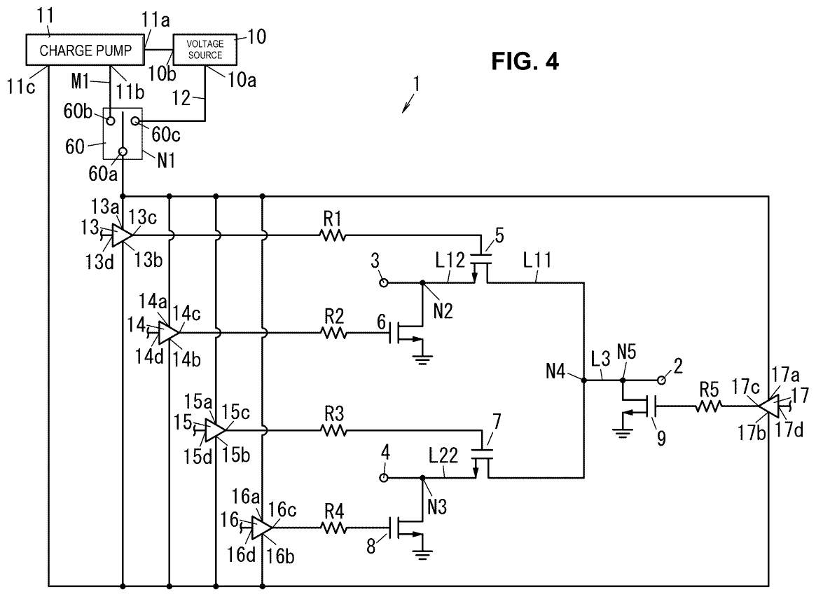

A radio frequency switching circuit 1 according to Exemplary Embodiment 2 will be described with reference to FIG. 3. In the following description, the same components as in Exemplary Embodiment 1 are denoted by the same reference numerals, and description thereof is omitted on occasions.

### 2-1 Configuration

In Exemplary Embodiment 1, the case where the control electrodes of all of the FETs 5 to 9 are connected to the connection node N1 is exemplified. In more detail, in Exemplary Embodiment 1, the case where the first input parts 13a to 17a of all of the first to fifth level shifters 13 to 17 are connected to the connection node N1. In contrast, in Exemplary Embodiment 2 as illustrated in FIG. 3, the respective control electrodes of the first serial FET 5 and the second serial FET 7 of the FETs 5 to 9 are connected to the connection node N1, likewise in the case of Exemplary Embodiment 1. The control electrodes of the remaining first to third parallel FETs 6, 8, and 9 are connected to a connection node N6 provided on the path M1a. The path M1a is a section of the first path M1 between the first output part 11b of the charge pump 11 and the connection node N1, the section being between the first output part 11b of the charge pump 11 and the first switch SW1.

In more detail, in Exemplary Embodiment 2, the first input parts 13a and 15a of the first level shifter 13 and the third level shifter 15 that are respectively provided for the first serial FET 5 and the second serial FET 7 are connected to the connection node N1. In contrast, the first input parts 14a, 16a, and 17a of the remaining first to third parallel FETs 6, 8, and 9 for the second, fourth, and fifth level shifters 14, 16, and 17 are connected to the connection node N6 provided on the path M1a.

That is, in Exemplary Embodiment 2, depending on whether the first switch SW1 and the second switch SW2 turn on or off, one of the output voltage of the first output part 11b of the charge pump 11 and the output voltage of the first output part 10a of the voltage source 10 is selectively applied to the first input parts 13a and 15a of the first level shifter 13 and the third level shifter 15. However, the output voltage of the first output part 11b of the charge pump 11 is always applied to the first input parts 14a, 16a, and 17a of the second, fourth, and fifth level shifters 14, 16, and 17, regardless of whether the first switch and the second switch turn on or off.

### 2-2 Operations

In the transmission/reception mode in Exemplary Embodiment 2, likewise in Exemplary Embodiment 1, the first switch SW1 is switched to on, and the second switch SW2 is switched to off. Accordingly, also in Exemplary Embodiment 2 likewise in Exemplary Embodiment 1, the output voltage (positive voltage) of the first output part 11b of the charge pump 11 is applied to the first input parts 13a to 17a of the first to fifth level shifters 13 to 17, and the output voltage (negative voltage) of the second output part 11c of the charge pump 11 is applied to the second input parts 13b to 17b of the first to fifth level shifters 13 to 17. Switching between on and off of the FETs 5 to 9 is then performed in accordance with control signals input to the control signal input parts 13d to 17d of the first to fifth level shifters 13 to 17, likewise in Exemplary Embodiment 1.

In the low power-consumption mode in Exemplary Embodiment 2, likewise in Exemplary Embodiment 1, the first switch SW1 is switched to off, and the second switch SW2 is switched to on. The output voltage (power supply voltage) of the first output part 10a of the voltage source 10 is thereby applied to the first input parts 13a and 15a of the first level shifter 13 and the third level shifter 15. In contrast, in the low power-consumption mode, the charge pump 11 is stopped, and thus the output voltages of the first output part 11b and the second output part 11c of the charge pump 11 become voltages close to zero volts. Accordingly, in the low power-consumption mode, a voltage close to zero volts is applied to the first input parts 14a, 16a, and 17a of the second, fourth, and fifth level shifters 14, 16, and 17, as the output voltage of the first output part 11b of the charge pump 11. To the second input parts 13b to 17b of the first to fifth level shifters 13 to 17, the output voltage (voltage close to zero volts) of the second output part 11c of the charge pump 11 is applied.

Also in Exemplary Embodiment 2 likewise in Exemplary Embodiment 1, in the low power-consumption mode, the first to fifth level shifters 13 to 17 cause all of the FETs 5 to 9 to switch to on. In more detail, in the low power-consumption mode, likewise in the case of Exemplary Embodiment 1 as described above, the output voltage (power supply voltage) of the first output part 10a of the voltage source 10 is applied to the first input parts 13a and 15a of the first and third level shifters 13 and 15, and thus the first serial FET 5 and the second serial FET 7 are switched to on due to the sufficiently high voltage (power supply voltage). Accordingly, likewise in the case of Exemplary Embodiment 1, even if a radio frequency signal from the external terminal apparatus enters the radio frequency switching circuit 1, the generation of the reflected wave of the radio frequency signal is reduced when the radio frequency signal passes through the first serial FET 5 and the second serial FET 7.

In the low power-consumption mode, as described above, the output voltage (voltage close to zero volts) of the first output part 11b of the charge pump 11 is applied to the first input parts 14a, 16a, and 17a of the second, fourth, and fifth level shifters 14, 16, and 17, and thus the first to third parallel FETs 6, 8, and 9 are switched to on due to the voltage close to zero volts. That is, the first to third parallel FETs 6, 8, and 9 are not switched to on sufficiently and have a high ON resistance to some extent in the on state. Accordingly, when a radio frequency signal from the external terminal apparatus enters the radio frequency switching circuit 1 and passes through the first to third parallel FETs 6, 8, and 9, a reflected wave of the radio frequency signal is generated on occasions. However, in Exemplary Embodiment 2, in the low power-consumption mode, the reflected wave of the radio frequency signal is reduced in the first serial FET 5 and the second serial FET 7. Accordingly, although Exemplary Embodiment 2 has less effects than those in Exemplary Embodiment 1, the reflected wave of the radio frequency signals may be reduced as a whole.

### 2-3 Advantageous Effects

Likewise in Exemplary Embodiment 1, the radio frequency switching circuit 1 according to Exemplary Embodiment 2 includes the common terminal 2, the first input/output terminal 3, the first serial FET 5, the first parallel FET 6, the charge pump 11, the voltage supply path 12, the first switch SW1, and the second switch SW2. The first input/output terminal 3 is connected to the common terminal 2 with the first signal path L1 interposed therebetween. The first serial FET 5 is connected to the common terminal 2 and the first input/output terminal 3 on the first signal path L1. The first parallel FET 6 is connected between ground and the signal path L12 between the first input/output terminal 3 and the first serial FET. The charge pump 11 supplies the control voltage for controlling the first serial FET 5 and the control voltage for controlling the first parallel FET 6. The voltage supply path 12 is connected to the connection node N1 connected to the first output part 11b of the charge pump 11 (output part) and the control electrode of the first serial FET 5. The first switch SW1 is provided on the first path M1 connecting the first output part 11b of the charge pump 11 and the connection node N1 and turns the first path M1 on and off. The second switch SW2 is provided on the voltage supply path 12 and turns the voltage supply path 12 on and off.

With this configuration, likewise in Exemplary Embodiment 1, in the state where the charge pump 11 is stopped, the first switch SW1 causes the first path M1 to turn off, and the second switch SW2 causes the voltage supply path 12 to turn on. Applying, to the control electrode of the first serial FET 5, the power supply voltage applied to the voltage supply path 12 may thereby cause the state of the first serial FET 5 to switch to the on state where the ON resistance is sufficiently low. Accordingly, the generation of the reflected wave of the radio frequency may be reduced, the generation being caused by the ON resistance of the first serial FET 5 when the radio frequency signal having entered the common terminal 2 from the external terminal apparatus passes through the first serial FET 5 in the state the charge pump 11 is stopped. As the result, the deterioration of the receiver sensitivity of the external terminal apparatus may be reduced, the deterioration being caused by the returning of the reflected wave to the external terminal apparatus.

### 3 Exemplary Embodiment 3

A radio frequency switching circuit 1 according to Exemplary Embodiment 3 will be described with reference to FIG. 4. In the following description, the same components as in Exemplary Embodiment 1 are denoted by the same reference numerals, and description thereof is omitted on occasions.

### 3-1 Configuration

As illustrated in FIG. 4, a radio frequency switching circuit 1 according to Exemplary Embodiment 3 has the same configuration as that of the radio frequency switching circuit 1 according to Exemplary Embodiment 1 except that the radio frequency switching circuit 1 according to Exemplary Embodiment 3 further includes a selector switch 60 instead of the first switch SW1 and the second switch SW2.

The selector switch 60 corresponds to a switch provided at the connection node N1 and including the first switch SW1 and the second switch SW2 in Exemplary Embodiment 1.

The selector switch 60 selectively connects, to the control electrodes of the FETs 5 to 9, one of the first path M1 and the voltage supply path 12 (in other words, one of the first output part 11b of the charge pump 11 and the first output part 10a of the voltage source 10).

In more detail, the selector switch 60 has a common terminal 60a, a first selection terminal 60b, and a second selection terminal 60c.

The first selection terminal 60b is connected to the first output part 11b of the charge pump 11 with the first path M1 interposed therebetween. The first selection terminal 60b is thus connected to one end portion of the first path M1. The second selection terminal 60c is connected to the first output part 10a of the voltage source 10 with the voltage supply path 12 interposed therebetween. The second selection terminal 60c is thus connected to one end portion of the voltage supply path 12. The common terminal 60a is selectively connected to one of the first selection terminal 60b and the second selection terminal 60c. The common terminal 60a is connected to the first input parts 13a to 17a of the first to fifth level shifters 13 to 17. The first to fifth level shifters 13 to 17 are provided for the FETs 5 to 9 on a one-to-one correspondence. The first to fifth level shifters 13 to 17 are also provided for the resistors R1 to R5 on a one-to-one correspondence. The output parts 13c to 17c of the first to fifth level shifters 13 to 17 are connected to the control electrodes of the corresponding FETs 5 to 9 with the resistors R1 to R5 interposed therebetween, the resistors R1 to R5 facing the output parts 13c to 17c, respectively. The common terminal 60a is thus connected to the control electrodes of the FETs 5 to 9. In more detail, the common terminal 60a is indirectly connected to the control electrodes of the FETs 5 to 9 with the corresponding first to fifth level shifters 13 to 17 and the corresponding resistors R1 to R5 interposed therebetween.

In the transmission/reception mode, the selector switch 60 selectively connects the common terminal 60a to the first selection terminal 60b. The selector switch 60 thus connects the first path M1 to the control electrodes of the FETs 5 to 9 in the transmission/reception mode. In more detail, the selector switch 60 connects the first path M1 to the first input parts 13a to 17a of the first to fifth level shifters 13 to 17. In the transmission/reception mode in Exemplary Embodiment 3, likewise in the transmission/reception mode in Exemplary Embodiment 1, the output voltage (positive voltage) of the first output part 11b of the charge pump 11 is thereby applied to the first input parts 13a to 17a of the first to fifth level shifters 13 to 17.

Since the output parts 13c to 17c of the first to fifth level shifters 13 to 17 are connected to the control electrodes of the corresponding FETs 5 to 9 with the resistors R1 to R5 interposed therebetween, the selector switch 60 connects the first path M1 to the control electrodes of the FETs 5 to 9 in the transmission/reception mode.

In the low power-consumption mode, the selector switch 60 selectively connects the common terminal 60a to the second selection terminal 60c. In the low power-consumption mode, the selector switch 60 thus connects the voltage supply path 12 to the control electrodes of the FETs 5 to 9. In more detail, the selector switch 60 connects the voltage supply path 12 to the first input parts 13a to 17a of the first to fifth level shifters 13 to 17. In the low power-consumption mode in Exemplary Embodiment 3, likewise in the low power-consumption mode in Exemplary Embodiment 1, the output voltage (power supply voltage) of the first output part 10a of the voltage source 10 is thereby applied to the first input parts 13a to 17a of the first to fifth level shifters 13 to 17.

Since the output parts 13c to 17c of the first to fifth level shifters 13 to 17 are connected to the control electrodes of the corresponding FETs 5 to 9 with the resistors R1 to R5 interposed therebetween, the selector switch 60 connects the voltage supply path 12 to the control electrodes of the FETs 5 to 9 in the low power-consumption mode.

### 3-2 Operations

The operations of the radio frequency switching circuit 1 in Exemplary Embodiment 3 are the same as the operations of the radio frequency switching circuit 1 in Exemplary Embodiment 1 except that the first switch SW1 and the second switch SW2 are changed to the selector switch 60, and thus the description thereof is omitted.

### 3-3 Advantageous Effects

The radio frequency switching circuit 1 according to Exemplary Embodiment 3 includes the selector switch 60. The selector switch 60 includes the first switch SW1 and the second switch SW2. The selector switch 60 selectively connects one of the first path M1 and the voltage supply path 12 to the control electrode of the first serial FET 5. With this configuration, the first switch SW1 and the second switch SW2 may be integrated into one by using the selector switch 60. As the result, the radio frequency switching circuit 1 may be downsized.

The embodiments and the modification described above are merely part of various embodiments and modifications of the present invention. The scope of the present invention is defined not by the description of the above embodiments, but by the claims, and it is intended that all equivalents to the claims and all modifications falling within the scope of the claims be included.

What is claimed is:

1. A radio frequency switching circuit comprising:
a common terminal;
a first input/output terminal connected to the common terminal with a first signal path interposed between the common terminal and the first input/output terminal;
a first serial field effect transistor (FET) connected, on the first signal path, to the common terminal and the first input/output terminal;
a first parallel FET connected between ground and a signal path between the first input/output terminal and the first serial FET;
a charge pump that has an output part and that supplies, from the output part, a control voltage for controlling the first serial FET and a control voltage for controlling the first parallel FET;
a voltage source that has a first output part and a second output part that supply respective voltages, the voltage source supplying a voltage from the second output part to the charge pump;
a voltage supply path that connects the first output part of the voltage source and a connection node that is operatively coupled to a control electrode of the first serial FET;
a first switch that is provided on a first path that connects the output part of the charge pump and the connection node and that turns the first path on and off; and
a second switch that is provided on the voltage supply path and that turns the voltage supply path on and off.

2. The radio frequency switching circuit according to claim 1,
wherein a control electrode of the first parallel FET is operatively coupled to the connection node.

3. The radio frequency switching circuit according to claim 2,
wherein the control electrode of the first parallel FET is operatively coupled to a path between the output part of the charge pump and the first switch.

4. The radio frequency switching circuit according to claim 1, further comprising:
a second input/output terminal connected to the common terminal with a second signal path interposed between the common terminal and the second input/output terminal;
a second serial FET that is connected, on the second signal path, to the common terminal and the second input/output terminal; and
a second parallel FET connected between ground and a signal path between the second input/output terminal and the second serial FET,
wherein the connection node is further operatively coupled to a control electrode of the second serial FET.

5. The radio frequency switching circuit according to claim 4, wherein the connection node is further operatively coupled to a control electrode of the second parallel FET.

6. The radio frequency switching circuit according to claim 1,
wherein the charge pump is configured to supply the control voltages based on the voltages from the voltage source.

7. The radio frequency switching circuit according to claim 1, further comprising:
a parallel FET connected between the common terminal and ground.

8. The radio frequency switching circuit according to claim 7, wherein the connection node is further operatively coupled to a control electrode of the parallel FET.

9. The radio frequency switching circuit according to claim 1, further comprising:
a selector switch including the first switch and the second switch,
wherein the selector switch is configured to selectively connect one of the first path and the voltage supply path to the connection node.

10. The radio frequency switching circuit according to claim 1, further comprising:
a first level shifter that controls the first serial FET; and
a second level shifter that controls the first parallel FET,
wherein the first level shifter has
a first input part operatively coupled to the connection node,
a second input part connected to the charge pump to receive a negative voltage, and
a first output part that is connected to the control electrode of the first serial FET and that selectively outputs one of a voltage input to the first input part and a voltage input to the second input part, and
wherein the second level shifter has
a third input part connected to a path between the output part of the charge pump and the first switch or to the connection node,
a fourth input part operatively coupled to the charge pump to receive the negative voltage, and
a second output part that is connected to the control electrode of the first parallel FET and that selectively outputs one of a voltage input to the third input part and a voltage input to the fourth input part.

11. The radio frequency switching circuit according to claim 1, wherein, in a first mode of operation, the first switch is configured to be in an on state and the second switch is configured to be in an off state.

12. The radio frequency switching circuit according to claim 11, wherein, in a second mode of operation, the first switch is configured to be in an off state and the second switch is configured to be in an on state.

13. The radio frequency switching circuit according to claim 12, wherein the second mode of operation is a low power-consumption mode in which the charge pump is stopped.

14. The radio frequency switching circuit according to claim 12, wherein in the low power-consumption mode, a voltage from the first output part of the voltage source is applied via the voltage supply path and the connection node to turn on the first serial FET with a low ON resistance.

15. A radio frequency module comprising:
the radio frequency switching circuit according to claim 1; and
an electronic component connected between the first input/output terminal of the radio frequency switching circuit and an external terminal.

16. A communication apparatus comprising:
the radio frequency module according to claim 15; and
a signal processing circuit that is connected to the radio frequency module and that performs signal processing of a radio frequency signal.

17. The communication apparatus according to claim 16, further comprising an antenna operatively coupled to the common terminal of the radio frequency switching circuit.

18. The communication apparatus according to claim 16, wherein the signal processing circuit comprises a baseband signal processing circuit and a radio frequency signal processing circuit.
